(19) United States
(12) Patent Application Publication
(10) Pub. No.: US 2011/0029819 A1
(43) Pub. Date: Feb. 3, 2011

(54) SYSTEM AND METHOD FOR PROVIDING PROGRAM TRACKING INFORMATION

(76) Inventors: Virendra Kumar Mehta, Cupertino, CA (US); Xiaohua Zhang, San Jose, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/533,625

(22) Filed: Jul. 31, 2009

(51) Int. Cl. G06F 11/07; G06F 9/45; G06F 11/36

(52) U.S. Cl. 714/38; 717/140; 714/E11.022; 714/E11.208

(57) ABSTRACT

There is provided a system and method of providing program tracking information. An exemplary method comprises compiling a program into a plurality of instruction bundles. The exemplary method also comprises placing an instruction to store program tracking information in a local path table or a global path table into at least one of the plurality of instruction bundles.

### BACKGROUND

Complex software applications are frequently executed in a production environment such as a data center. In many cases, the company or entity that runs the application in the data center is not the developer of the application. The developer frequently does not have ready access to the systems on which the application is running after the application is placed into production. However, if the software application crashes or suffers from other undesirable performance problems in the production environment, the developer may be called upon to identify and remedy the problem.

Many computing systems typically provide a record of a software failure in the form of a core file. The core file may include a record of memory locations addressed by a program prior to failure. The core file, however, may not provide sufficient information to allow a developer of a complex software application to effectively identify a specific cause of failure for a complex software application.

### BRIEF DESCRIPTION OF THE DRAWINGS

Certain exemplary embodiments are described in the following detailed description and in reference to the drawings, in which:

FIG. 1 is a diagram of a computer network in accordance with an exemplary embodiment of the present invention;

FIG. 2 is a process flow diagram showing a method for recovering program execution paths with a core file in accordance with an exemplary embodiment of the present invention;

FIG. 3 is a block diagram of a global path table in accordance with an exemplary embodiment of the present invention;

FIG. 4 is a block diagram of a local path table in accordance with an exemplary embodiment of the present invention;

FIG. 5 is a block diagram showing a compile-time and run-time system for recovering program execution paths from core files in accordance with an exemplary embodiment of the present invention;

FIG. 6 is a process flow diagram showing a method of operation of a compiler and debugger to enable backtracking of execution paths in accordance with an exemplary embodiment of the present invention;

FIG. 7 is a process flow diagram showing a method of providing program tracking information according to an exemplary embodiment of the present invention;

FIG. 8 is a chart showing local path table performance in accordance with an exemplary embodiment of the present invention;

FIG. 9 is a chart showing configurable global path table performance in accordance with an exemplary embodiment of the present invention; and

FIG. 10 is a chart showing fixed-size global path table performance in accordance with an exemplary embodiment of the present invention.

### DETAILED DESCRIPTION OF THE PREFERRED EMBODIMENTS

Exemplary embodiments of the present invention relate to systems and methods for providing program tracking information to facilitate the determination of program execution paths after a fatal error or crash of a computer program.

One exemplary embodiment of the present invention provides a core file that includes sufficient information to backtrack execution of the application. A core file contains the results of a core dump. Moreover, a core file may comprise a recorded or saved state of the working memory of a computer program at a specific time when the computer program has abnormally terminated or crashed. Key pieces of the program state are dumped at the same time and include one or more of processor registers (such as program counter and stack pointer), memory management information, processor system flags, and OS flags. In accordance with an exemplary embodiment of the present invention, a core file includes program tracking information that was provided by instructions embedded in the program executable code when the program was compiled. This program tracking information allows a user to determine a program execution path if the program experiences a fatal error or crash.

In one exemplary embodiment of the present invention, a fatal error in a program or a crash automatically triggers a core dump. In general, a fatal error or crash is an error that causes a program to abort and may return the user to the OS. Examples of situations that may cause a fatal error or crash include an attempt to execute an illegal instruction, an attempt to access invalid code or data, an attempt to divide by zero or the like.

A compiler that is used to compile the program, a run-time library used at compile time, and a debugger may be used in an exemplary embodiment of the present invention employ program tracking information inserted into an executable program at compile time to enable backtracking of the execution path from a breakpoint in a debugger or from the core file. Exemplary embodiments of the present invention may allow the location of a failure to be determined without inserting a trace program in the application. Instead, the information provided in the core file is sufficient to recover the execution path and determine the point or location of failure.

In one exemplary embodiment of the present invention, execution data is captured and made available for offline analysis (using the core file) or online analysis (directly in a debugger) without the need for run-time environment modifications. The core file may be used as an exemplary mechanism for offline analysis after a crash or failure. Dumping of the core file, however, can be accomplished through other mechanisms in the OS as well.

One or more path tables may be used to keep track of the execution path of the software application. These path tables are saved in memory and then dumped with the core file after a fatal error or crash. The information in the core file coupled with the information in the path tables enables an analysis tool or debugger to backtrack the execution path from a breakpoint and determine the cause of the failure. Furthermore, one exemplary embodiment analyzes a call stack in the core file to assist in determining an execution path of the application.

Those of ordinary skill in the art will appreciate that the various functional blocks shown in the accompanying figures may comprise hardware elements (including circuitry), software elements (including computer code stored on a machine-readable medium) or a combination of both hardware and software elements. Moreover, the arrangements of functional blocks shown in the figures are merely examples of functional blocks that may be implemented according to an exemplary embodiment of the present invention. Other arrangements of functional blocks may readily be determined by those of ordinary skill in the art based on individual system design considerations.

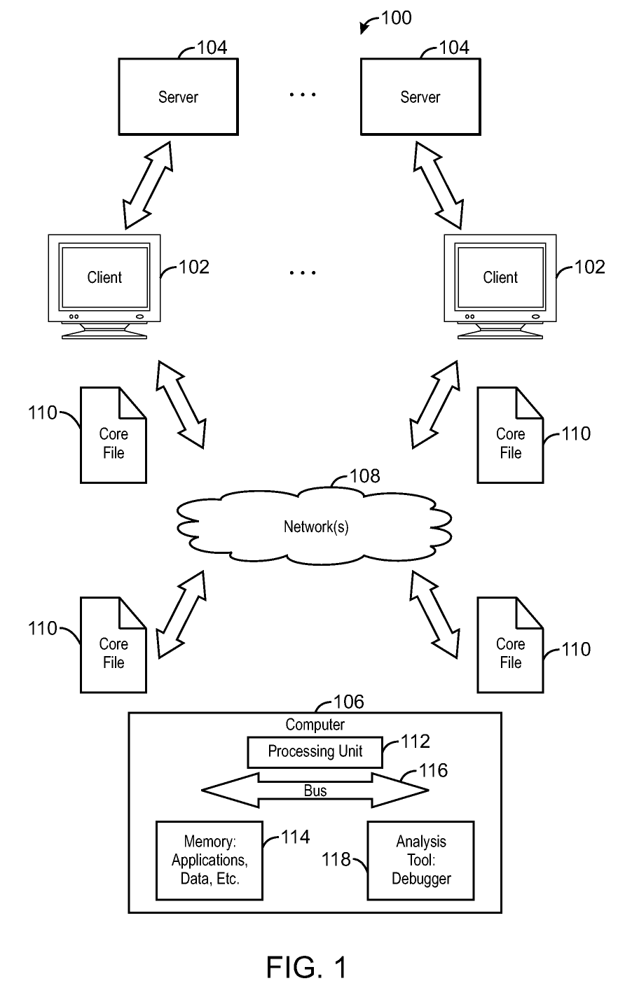

FIG. 1 is a diagram of a computer network 100 in accordance with an exemplary embodiment of the present invention. The computer network 100 includes a plurality of end users or client computers 102 in communication with a plurality of servers 104, such as one or more database servers, file servers, application servers, web servers or the like. The client computers 102 in turn communicate with one or more offsite computers 106 (one offsite computer 106 being shown for illustration) through one or more networks 108.

The client computers 102 and the servers 104 represent a production computing environment operating, for example, in a data center or the like. When a fatal error or a crash of a program executed on one of the computers 102 or the servers 104 occurs, quick analysis identifying the reason for the crash and implementation of a solution is desirable. As described in detail below, a fatal error or crash of a program executing on one of the computers 102 or the servers 104 results in the generation of a core file 110. In an exemplary embodiment of the present invention, the core file 110 is created in such a way that it contains program tracking information that will allow an execution path of program flow prior to an event such as a crash to be determined.

After the core file 110 is generated, it may be transmitted via the network 108 to the offsite computer 106 for analysis. In one exemplary embodiment of the present invention, the offsite computer 106 is operated by a company or other entity that provides support to the production computing environment of which the computers 102 and the servers 104 are a part.

The offsite computer 106 is used to determine an execution path of a failed program or application executed on one or more of the client computers 102 or servers 104. The offsite computer 106 includes a processing unit 112 (such as one or more processors or central processing units, CPUs) for controlling the overall operation of a memory 114 (such as random access memory (RAM) for temporary data storage and read only memory (ROM) for permanent data storage). The memory 114, for example, stores applications, data, control programs, algorithms (including diagrams and methods discussed herein), and other data associated with the offsite computer 106. The processing unit 112 communicates with the memory 114 and many other components via a bus 116. The offsite computer 106 also includes an analysis tool or debugger 118 that may be used to identify an execution path of a failed program according to an exemplary embodiment of the present invention.

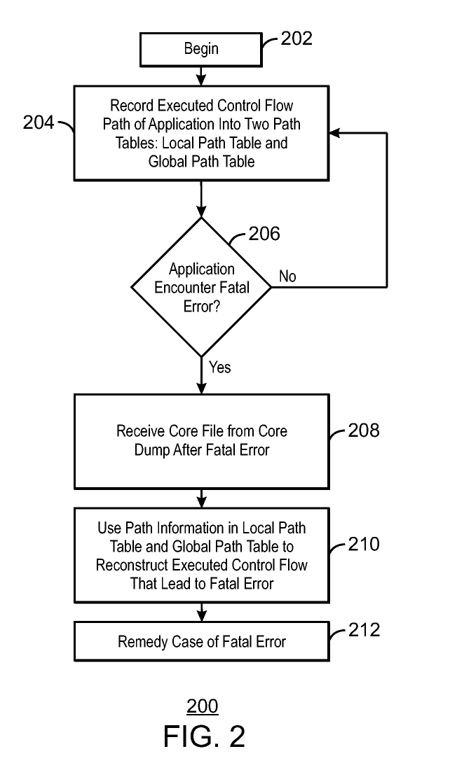

FIG. 2 is a process flow diagram showing a method for recovering program execution paths with a core file in accordance with an exemplary embodiment of the present invention. The method is generally referred to by the reference number 200.

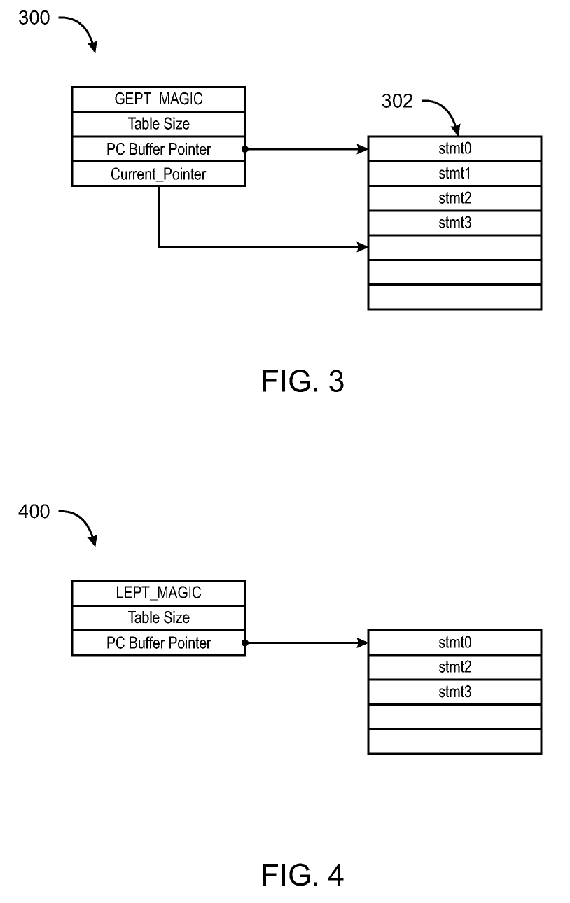

At block 202, the method 200 begins. The method 200 may be implemented at least in part by an application program that executes on a client computer and/or server (such as the offsite computer 106 shown in FIG. 1). A program that performs the method 200 is compiled by compiler 502 and is instrumented to record path information to a global path table 300 (see FIG. 3) and/or a local path table 400 (see FIG. 4).

As shown at block 204, program tracking information in the form of executed control flow path data of the application is recorded into two path tables: a local path table and a global path table. In one exemplary embodiment of the invention, the data stored in the path tables is enhanced by virtue of the compiler and run-time libraries used to create the executable version of the application program that is being analyzed. Moreover, the compiler and run-time libraries may be modified to include program tracking information such as executed control flow path information in the two path tables. The local path table may be a per method path table and the global path table may be a per thread path table implemented as a circular buffer of configurable size. A debugger according to an exemplary embodiment of the present invention is adapted to interpret the information stored in the path tables to recreate an execution path of the application program prior to its failure.

The program tracking information stored in the path tables may be used to reconstruct the executed control flow that led to the crash in case of a core file creation. The path information may also used during online debugging to show the executed path before a break point. An exemplary circular buffer records each executed basic block's PC (program counter) address in First-In-First-Out order (FIFO). When the end of buffer is reached, the pointer is wrapped back to the beginning of the buffer.

The local path table is allocated in stack for each routine that has path information to be recorded. In one exemplary embodiment, the size of local buffer is the same as the number of if-else, switch-case, try-catch statements in user source code. So each of these control statements has one corresponding slot in the local path buffer. When the control statements are in loop statements (for example, for, while, do-while), the corresponding slots are reset when the control flow loops back.

In one exemplary embodiment, the global path table keeps all path information including paths inside loops and paths in routines that are returned. Since the global path table has limited size, the table does not store all the path information. Therefore, the local path table may be adapted to store or save all path information for routines in the stack.

At block 206, a determination is made regarding whether the software application has encountered a fatal error or crash. If no fatal error or crash has occurred, process flow returns to block 204, where program tracking information continues to be recorded to the local and global path tables.

If, at block 206, a determination is made that a fatal error or crash has occurred, a core dump is executed to produce a core file (such as the core file 110 shown in FIG. 1), as shown at block 208. As discussed above with reference to FIG. 1, the core file may be transmitted to a computer such as the offsite computer 106 shown in FIG. 1 for execution path analysis according to an exemplary embodiment of the present invention. Moreover, the core file information, including program tracking information from the local path table and the global path table may be used to reconstruct executed control flow that lead to the fatal error or crash, as shown at block 210. When the execution path is identified, the cause of the fatal error or crash may be determined.

As shown at block 212, a problem that resulted in the fatal error or crash may be remedied. For example, changes may be made to the source code of the software application to remedy the cause of the fatal error or crash. In an exemplary embodiment of the present invention, an analysis tool or debugger 118 (FIG. 1) may be adapted to display the cause of the fatal error or crash to a user, so that the application or hardware that led to the fatal error or crash may be updated or corrected.

Exemplary embodiments of the present invention are not limited to determining execution paths for fatal errors or crashes. Moreover, exemplary embodiments can also be used to determine other instances including, but not limited to, determining the root cause of any application problem such as hangs, incorrect logic, interoperability issues, performance problems, or the like. Furthermore, exemplary embodiments of the present invention can be implemented in various stages of an application, such as the development or testing stage to the production stage (in other words, after the software application is sold or licensed by a software developer and for implementation by a purchaser).

FIG. 3 is a block diagram of a global path table in accordance with an exemplary embodiment of the present invention. The global path table is generally referred to by the reference number 300. The global path table 300 may be one of two types. A first type has a run-time configurable size and can dump its contents to a file when the table is full. A second type comprises a table of fixed size for best run-time performance. The user can choose which global path table to use based on system usage and needs of a particular implementation.

The global path table 300 may include a circular buffer 302. The circular buffer 302 may be adapted to record each executed basic block's PC address in First-In-First-Out order (FIFO). When an end of the buffer is reached, a pointer wraps back to the beginning of the buffer. If at run-time, the control flow branches, then the branch information is recorded into the global path table 300, and the path table current index is increased.

Since the global path table 300 has limited size, it will eventually be overwritten with new path information. If there is a loop in program flow, a worst-case scenario is that the global path table could be flooded with a few duplicated path entries. Such entries will not provide users much useful information regarding what is beyond the loop. To solve this problem, a user could either dump the contents of the global path 300 to a file then use the path table stored in the file to reconstruct the full program path trace or use a local path table (see FIG. 4 below) to compensate for the loss of global path information.

As mentioned above, there may be two types of global path tables. In one exemplary embodiment, the user picks one for the whole program. After a path table type is chosen, the user compiles the application consistently with the selected path table type. The configurable global path table 300 may provide improved cost in terms of run-time performance. One exemplary embodiment of the present invention provides conditional logic to test if the global path table 300 is full before each write to the global path table 300.

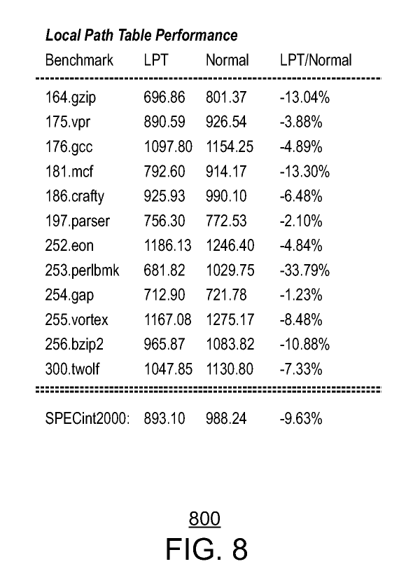

A simple conditional logic will not significantly affect application performance, but run-time performance data shows that it almost doubles the overhead compared to fixed-size global path table (20% vs. 10% for SPECint2000, see the tables set forth in FIGS. 8-11). By way of example, the fixed size global path table may have 65,536 entries for path information, and the index to the table may have an unsigned short type. When the index increases to 65,536, it automatically resets to zero and, hence, removes the need to reset the index pointer by logical comparison. Since there is no comparison when writing to fixed size global table, the contents are not dumped before the index wraps back. Furthermore, there is another consideration for fixed size global table because there may be one global path table for each thread of an application. If an application has many threads running concurrently, the memory consumption for a fixed-size table could be high. Depending on whether the table is a 64-bit mode table or not, one table could have 512 KB (kilobytes) for 64-bit PC address or 256 KB for 32-bit address. In one example, the default size of a configurable global path table is 8K entries, which is 8 times smaller than the fixed size global path table.

In one exemplary embodiment, the global path table 300 has the limitation of being unable to record all the path traces in the table. Even for the routines still live in a stack, the path trace can get lost. Though a configurable global path table could dump its contents to a file to keep the whole program execution path, it is unrealistic for a user to perform manual analysis on a whole program path to find points that may have contributed to the failure of the application without the help of some kind of special analysis tool. The routines still living in the stack tend to be more likely to have had an impact on the failure than the routines already returned. To record the path trace for living routines, exemplary embodiments of the present invention use a local path table of the type described below with reference to FIG. 4.

FIG. 4 is a block diagram of a local path table in accordance with an exemplary embodiment of the present invention. The local path table is generally referred to by the reference number 400.

In one exemplary embodiment, the local path table 400 performs two functions: (1) the table maintains path traces for all living routines, and (2) the table does not overflow even in a loop. Thus, the local path table 400 may be allocated for each routine at entering time and destroyed at return time. If the routine has no branches, then no local path table is created for the routine. The size of local buffer is decided at compile-time and is based on the number of if-else, switch-case, and try-catch statements in user source code. A compiler/linker according to an exemplary embodiment of the present invention may be adapted to try to minimize the table entries in the local path table 400 by sharing an entry with disjointed branches. Each of these control statements may have one corresponding slot in the local path table 400, which may be shared with by exclusive block's branch. When in loop statement (for, while, do-while), the corresponding slots are reset when the control flow loops back. If the entries are not reset when a loop back occurs, a pervious loop's branch path information will undesirably intermingle with the information regarding the current loop.

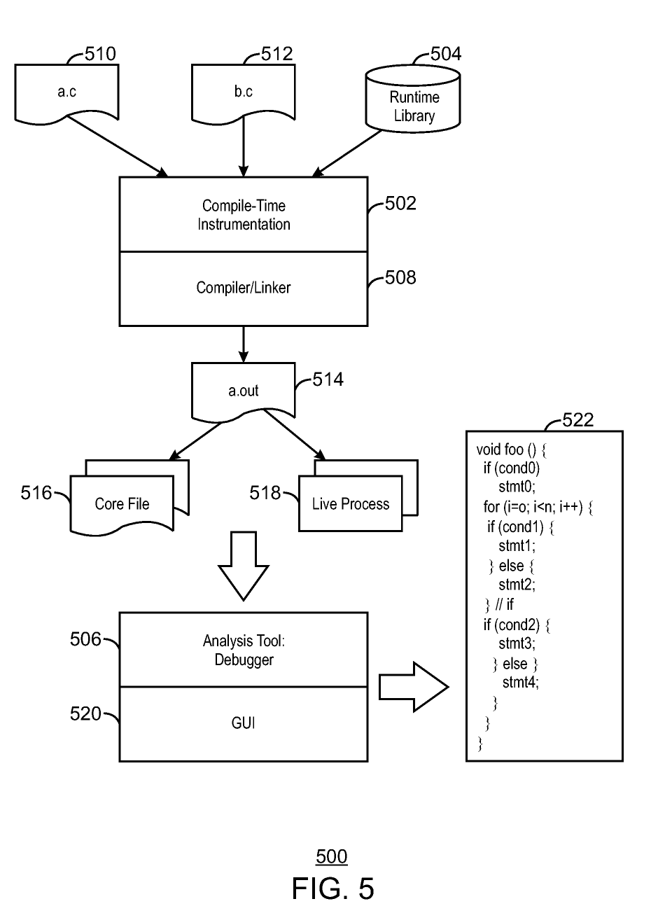

FIG. 5 is a block diagram showing a compile-time and run-time system for recovering program execution paths from core files in accordance with an exemplary embodiment of the present invention. The system is generally referred to by the reference number 500. The system includes three parts: compile-time instrumentation 502, a run-time library 504, and an analysis tool or debugger 506. The compile-time instrumentation 502 may be integrated with a compiler/linker 508 and may compile a.c files 510 and b.c files 512, and link with run-time library 504 to generate executable file a.out 514. Those of ordinary skill in the art will appreciate that the compile-time instrumentation 502, the compiler/linker 508, the run-time library 504 and other functional blocks shown in FIG. 5 may be implemented as machine-readable instructions stored on a tangible, computer-readable medium such as a storage device. Executing the output file from the compiler/linker 508 (shown as an executable a.out file 514) may generate a core file 516, or a live or actively running process 518.

The core file 516 is provided to the analysis tool 506 which includes a graphical user interface (GUI) 520. The analysis tool 506 maps the path information in the core file 516 or live process 518 back to source file information such as illustrated in a source file code snippet 522.

In one exemplary embodiment, the system 500 provides a low intrusion always-on instrumentation solution using the compiler 508 and the debugger 506 to provide enough program tracking information of the execution path to be able to backtrack execution. Moreover, the compiler/linker 508 is adapted to employ the compile-time instrumentation 502 to insert memory writes into the executable a.out file 514. As explained below, these memory writes are strategically chosen to not interfere with the normal operation of the executable a.out file 514, but to provide information to the path tables described above with reference to FIGS. 2-4 to allow identification of an execution path that resulted in a fatal error or crash.

Some processors use instruction-level parallelism wherein the compiler/linker 508 makes decisions about which instructions are executed in parallel. In such a system, it is desirable to bundle together instructions that do not interfere with each other for parallel execution. In practical application, many instruction bundles wind up including empty slots or NOPs (no operation instructions) because it is difficult to find parallelism between instructions due to the amount of dependence between them. An exemplary embodiment of the present invention exploits this situation by inserting tracking instructions, such as memory writes, into the empty slots to provide program tracking information to the local and global path tables referred to above with reference to FIGS. 2-4. Moreover, such an exemplary embodiment may create a stream of memory writes into memory areas that do not tangle program flow. Thus, program tracking information may be provided without additional cost to the program execution (for example, execution of the program is not slowed).

In one exemplary embodiment of the present invention, the compile-time instrumentation 502 is adapted to find control flow branches in program flow and to insert code to get the PC address and record the address to the path table in an empty slot in an instruction bundle. The PC address is the first statement of a branch to a basic block, so the analysis tool 506 can be adapted to map the PC address back to a specification location in source code used to create the a.out file 514.

To help find the control flow in the user's source code instead of the control flow after compiler optimization and transformation, the compile-time instrumentation 502 may insert markers in an intermediate code stream. These markers are specially treated by the compiler/linker 508 to not interfere with the normal optimization of the program. In one exemplary embodiment, this instrumentation happens after all high level optimization is done (including in-lining), but before lower level optimization (such as if-conversion). Thus, the path information will still be recorded in the path tables even if the branch is converted to predicated instructions by the process of if-conversion. Another reason to perform optimization according to an exemplary embodiment of the present invention after in-lining is to allow the reconstruction of a pre-existing local path table (if one exists) to produce a new path table that includes tracking information placed into the instruction stream by the compile-time instrumentation 502.

The run-time library 504 may be adapted to perform complex operations that cannot be easily performed by the compile-time instrumentation 502. Moreover, the run-time library 504 may be adapted to check an environment variable of run-time configurations and to initialize a global path table for each thread of an application. When the global path buffer is full, the run-time library 504 can write the contents to a user-specified file in a specified format (for example, raw format and text format). The path information can also be used to do more post-analysis by any value-added analysis tool. For example, one use of the path information is to collect path test coverage.

The analysis tool 506 may be adapted to perform core file analysis and/or debugging. In both cases, the analysis tool 506 finds the global and local path tables. The global and local path tables may be identified by a symbol table, which is a data structure used by tools such as dynamic loader or debugger. In a symbol table, each identifier in the source code of a program is associated with information relating to its declaration or appearance in the source code, such as its type, scope level, and location. Object files contain symbol tables of identifiers, and a linker uses the symbol tables to resolve unresolved references during the linking of different object files. Symbol tables may be embedded in the output of the translation process for use in subsequent debugging or as a resource for diagnostic reporting.

The global and local path tables may contain “magic numbers” (identifiers) to help the analysis tool 506 to find them if they cannot be found using the symbol table. By way of example, the symbol table may have been stripped, whereupon it would not contain any references to the local or global path tables. Examples of magic numbers that may be used include GEPT_MAGIC for the global path table and LEPT_MAGIC for the local path table. The use of identifying information makes the path tables easier to find when analyzing thread local data or the stack.

After finding the path tables, the analysis tool 506 may map the path information (PC address) back to the source line information by using the line table in the object files. The analysis tool 506 may then show the executed blocks by highlighting the statements in the source file 522. The analysis tool 506 may also be adapted to support user commands to navigate through the paths (for example, list next/previous N path for thread M, set path N to current path, show assembler code with path info, show source file with path info or the like).

By designing the generated information as if it were programmer inserted code, exemplary embodiments of the present invention may provide binary compatibility to debuggers that are not modified according to an exemplary embodiment of the present invention without the need for special object code format changes. By way of example, one exemplary embodiment of the present invention may be implemented in C and C++ compiler front-ends and back-ends for a particular processor on a particular operating system.

The analysis tool/debugger 506 may be employed to read the contents of the core file 110 (FIG. 1.) In one exemplary embodiment of the present invention, the core file 110 may include memory images and a stack trace, as well as an instruction pointer of an execution point at the point of core file generation. Commands may be used to identify and display a point in the program where execution stopped. In addition, a call stack may be displayed.

One exemplary embodiment begins by identifying the point of execution from where a user desires to backtrack execution. A “pathtrace” command that shows the path taken to reach a particular point in the method may be employed. As a user traverses up the stack, the pathtrace command may be used to show the point of the call was reached. A new pathtrace command is then issued to determine the execution path. Thereafter, exemplary embodiments can either use the information to answer specific questions about the state of the program desired to know, or set breakpoints at prior points in execution and re-run to get more refined information.

In one exemplary embodiment, the pathtrace command can be used at any point in the execution of a program while in the debugger. At any breakpoint, the pathtrace command can be issued to determine how a point was reached (in other words, to trace its path of execution). This is especially beneficial in multi-threaded applications, or non-trivial applications where the execution path can change significantly from run to run even with controlled input. It is sometimes easier to set a breakpoint in these cases to a point where a user knows that the control is expected to reach. In this instance, the pathtrace command is used to see the path taken, set breakpoints and re-run if needed, or figure out how the process state was modified to reach this point.

In one exemplary embodiment, the core file is generated using a dump core command of the analysis tool/debugger 506, by using the application tool, or by otherwise specifying the core action. The last two approaches may be used to generate core files at strategic points of execution of a live process, and may be used to differentiate states at these multiple points where the core file was generated.

In one exemplary embodiment, a separate tool runs alongside the program that is being analyzed, to monitor events in the program. A debugger may be attached to the program as one possible action when an event is triggered. Once the debugger is attached, one exemplary embodiment of the present invention uses the pathtrace command to display the path taken. Both in this case, as well as debugger attach case, exemplary embodiments can also run the debugger in a batch mode and thus collect path trace at several points during execution.

In one exemplary embodiment, the analysis tool/debugger 506 implements some form of checkpointing, which enables exemplary embodiments to revert to a prior state of execution and then continue, presumably by altering some state variable to get a different execution next time. This feature can be used in conjunction with the pathtrace command. For example, a breakpoint may be set later in the program to analyze the execution path. A prior stable point is picked in the execution to be a checkpoint, and then a restart is provided. If a breakpoint is encountered having come through the same path the next time, one exemplary embodiment backtracks and modifies the state to see its effect as we move forward and hit the breakpoint again. If it is determined that the checkpoint was not hit, the pathtrace command is used to see which path was taken this time. A checkpoint along the alternate route can be selected, and so on, until a sufficient set of checkpoints is selected to enable the analysis.

One exemplary embodiment modifies the compiler backend to generate appropriate code to keep track of the information. The analysis tool/debugger 506 may also be modified to read the corresponding information and to draw out a conditional map of execution when requested, both from the core file, and for online debugging.

Exemplary embodiments can be used with alternate mechanisms to backtrack execution and modify the state. Traditionally, this task has been difficult due to the amount of state that is used to save whenever a state change happens in a non-trivial application. The traditional solution is to use checkpointing where the entire state can be dumped and restored. Inserting incremental state saves as state changes is costly both in terms of execution cost as well as the space needed to hold the changes. However, with the improvements in processor speeds as well as memory availability, this is now feasible for specific portions of code, and one embodiment can either turn these on using pragmas statically or dynamically based on environment settings. This can lead to faster debugging (assuming that it minimally affects the non-debug executions).

With any form of instrumentation, there is a risk of performance slowdown which works inversely to its adoption. The solution typically is to somehow do the instrumentation dynamically if needed. This solution is possible to implement with Java or other similar dynamic languages that have the capability to dynamically generate, and regenerate execution code. Exemplary embodiments can use various ways of bringing similar capabilities to static language programs. For example, such approaches range from multiple copies of statically generated code in a fat binary to dynamic optimizer generated code.

A dynamic optimizer improves code performance at run time based on the system parameters at run time. Independent software vendors typically compile at lowest common levels of architecture in order to have their code run on all sorts of systems. This can leave significant performance on the table as the same old static binary moves through successive improved systems. Dynamic optimizers can help get around this issue by regenerating code at run time. Exemplary embodiments can enhance such a dynamic optimizer to generate instrumentation for path trace information.

Furthermore, fat binaries are significantly easier to generate then a dynamic optimizer however, and with disk space premium coming down, it is becoming a popular solution. As such, exemplary embodiments can add capabilities to send messages to the process to switch to the instrumented code. For example, this can be accomplished using the dynamic loader which can modify the stubs to point to the different code. This solution keeps both optimized and debuggable code in the same binary to help with debugging in production systems.

As noted, when non-trivial applications fail with a core file, exemplary embodiments enable a user or computer to determine the execution path take to reach the instruction described in the crash file. To perform these tasks, exemplary embodiments modify compilers and debuggers to enable backtracking of the execution path from a breakpoint in a debugger or from a core file.

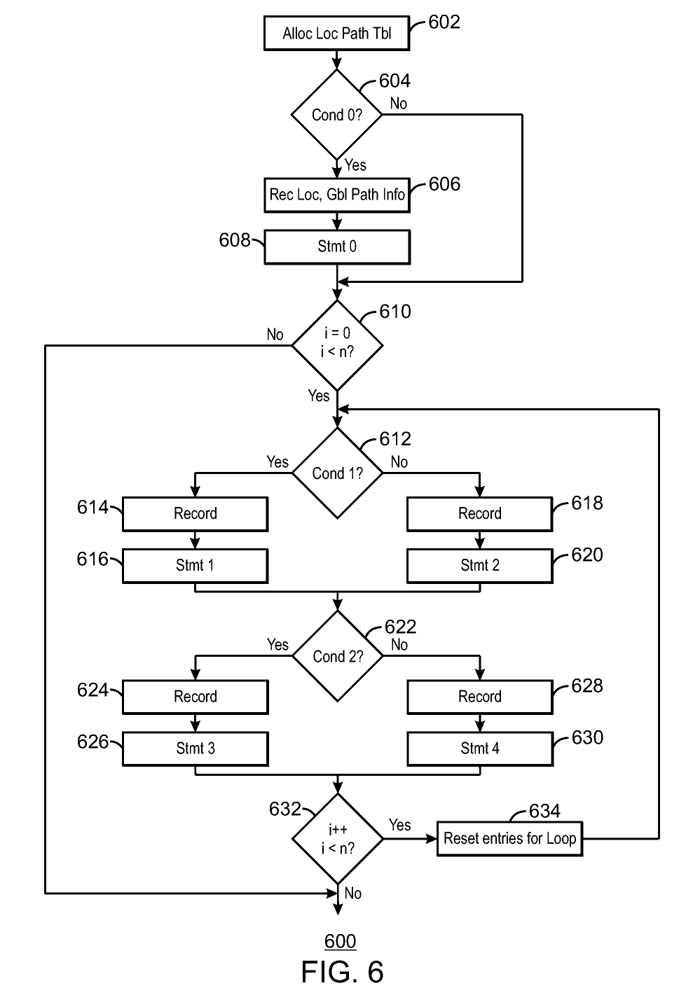

FIG. 6 is a process flow diagram showing a method of operation which is instrumented by a compiler from the source code 522 to enable backtracking of execution paths in accordance with an exemplary embodiment of the present invention. The method is generally referred to by the reference number 600.

At block 604, a determination is made with respect to whether a condition (Cond 0) has been met. The condition could be considered to be met if a variable is tested and returns a value of zero. If, at block 604, the condition is met, program flow proceeds to block 606, where program tracking information is written to local and global path tables, as described above. The local and global path table information stored at block 606 (and subsequent blocks shown in FIG. 6) allows a user to identify a program execution path that led to a fatal error or crash, as explained in detail above. Moreover, a core file provided as a result of a fatal error or crash, or at the request of a user, contains information stored in the local and global path tables to facilitate determination of the execution path. Statement 0, corresponding to the occurrence of the condition tested at block 604, is then executed, as shown at block 608.

If, at block 604, the condition is not met, program flow continues at block 610, skipping over blocks 606 and 608. The first time program flow proceeds to block 610, a loop counter variable i is initialized to zero. When block 610 is encountered on subsequent occasions, the loop counter i is not initialized. A determination is then made regarding whether the value of i is less than a predetermined variable n. If the value of i is not less than the value of n at block 610, the method ends.

If, at block 610, the value of i is less than the value of n, program flow proceeds to block 612. At block 612, a determination is made regarding to whether a condition (Cond 1) has been met. If Cond 1 is met, program flow proceeds to block 614, where tracking information is written to local and global path tables, as described above. A statement corresponding to the occurrence of the condition tested at block 612 is then executed, as shown at block 616. Program flow then continues at block 622.

If, at block 612, the condition (Cond 1) has not been met, program flow proceeds to block 618, where program tracking information is written to local and global path tables, as described above. A statement corresponding to the non-occurrence of Cond 1 is then executed, as shown at block 620. Program flow then continues at block 622.

At block 622, a determination is made regarding to whether a condition (Cond 2) has been met. If Cond 2 is met, program flow proceeds to block 624, where program tracking information is written to local and global path tables, as described above. A statement corresponding to the occurrence of the condition tested at block 622 is then executed, as shown at block 626. Program flow then continues at block 632.

If, at block 622, the condition (Cond 2) has not been met, program flow proceeds to block 628, where tracking information is written to local and global path tables, as described above. A statement corresponding to the non-occurrence of Cond 2 is then executed, as shown at block 630. Program flow then continues at block 632.

At block 632, the value of i is incremented and then compared to the value of n. If the incremented value of i is not less than n, the method ends. If, at block 632, the incremented value of i is less than n, program flow proceeds to block 634. At block 634, loop entries are reset in a local path table before program flow proceeds to block 612. Thus, the local path table maintains program tracking information for a current loop being executed.

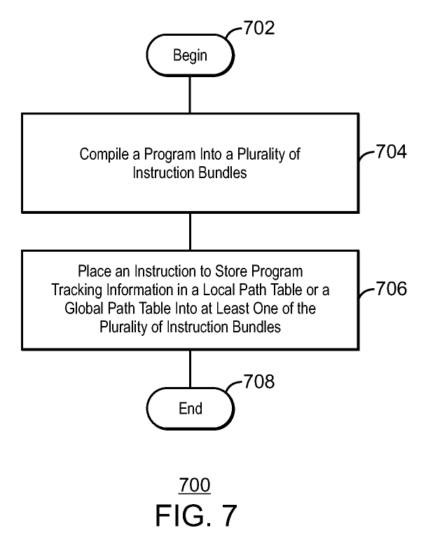

FIG. 7 is a process flow diagram showing a method of providing program tracking information according to an exemplary embodiment of the present invention. The method is generally referred to by the reference number 700. The method 700 begins at block 702.

At block 704, a program such as a source code program is compiled into a plurality of instruction bundles. As the program is compiled, an instruction to store program tracking information in a local path table or a global path table is placed into at least one of the plurality of instruction bundles, as shown at block 706. The program tracking information may be used as described herein to identify an execution path that results in a fatal error or crash of the compiled program. The method ends at block 708.

As set forth above, exemplary embodiments of the present invention can be used for both optimization and debugging. Exemplary data for local and global path tables, as well as their performance, is shown with reference to FIGS. 8-10.

FIG. 8 is a chart showing local path table performance in accordance with an exemplary embodiment of the present invention. The chart is generally referred to by the reference number 800.

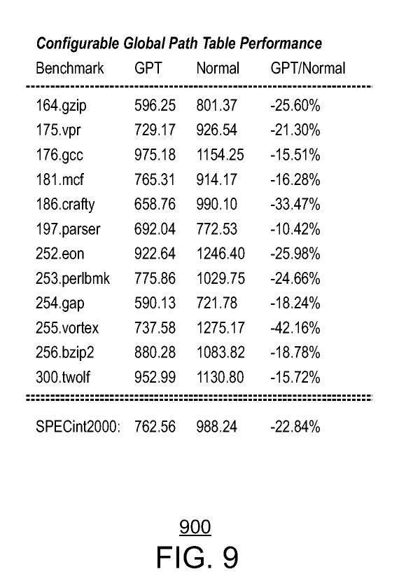

FIG. 9 is a chart showing configurable global path table performance in accordance with an exemplary embodiment of the present invention. The chart is generally referred to by the reference number 900.

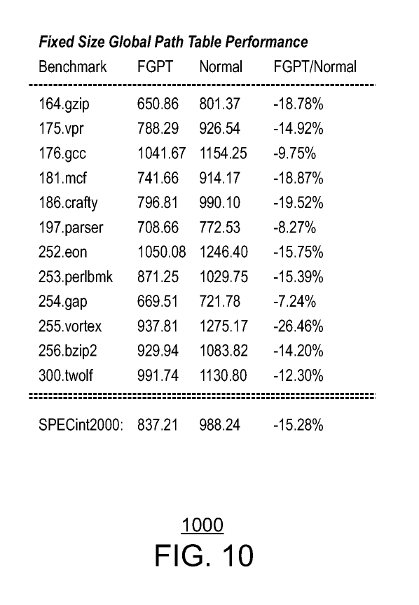

FIG. 10 is a chart showing fixed-size global path table performance in accordance with an exemplary embodiment of the present invention. The chart is generally referred to by the reference number 1000.

What is claimed is:

1. A method for providing program tracking information, the method comprising:
compiling a program into a plurality of instruction bundles; and
placing an instruction to store program tracking information in a local path table or a global path table into at least one of the plurality of instruction bundles.

2. The method recited in claim 1, wherein the program tracking information stored in the local path table relates to execution of program loops.

3. The method recited in claim 1, wherein the global path table is of a fixed size.

4. The method recited in claim 1, wherein the local path table is of a variable size.

5. The method recited in claim 1, comprising providing a core file containing the program tracking information.

6. The method recited in claim 1, comprising operating a debugger to read the program tracking information.

7. The method recited in claim 1, wherein the instruction to store program tracking information is placed at a location in the instruction bundle that would otherwise be occupied by a no-operation instruction to minimize a performance impact on the program.

8. The method recited in claim 1, comprising:
reading the program tracking information; and
determining an execution path leading to a fatal error or crash based on the program tracking information.

9. The method recited in claim 1, wherein the program tracking information is added after a process of in-lining and prior to a process of if-conversion.

10. The method recited in claim 1, wherein the program tracking information comprises a program counter address of each executed basic block of the program.

11. A system for providing program tracking information, the system comprising:
a processor that is adapted to execute machine-readable program instructions; and
a compiler that is adapted to run on the processor, to compile a program into a plurality of instruction bundles, and to place an instruction to store program tracking information in a local path table or a global path table into at least one of the plurality of instruction bundles.

12. The system recited in claim 11, wherein the program tracking information stored in the local path table relates to execution of program loops.

13. The system recited in claim 11, wherein the global path table is of a fixed size.

14. The system recited in claim 11, wherein the local path table is of a variable size.

15. The system recited in claim 11, wherein the program tracking information is included in a core file.

16. The system recited in claim 11, comprising a debugger that is adapted to read the program tracking information.

17. The system recited in claim 11, wherein the compiler is adapted to place the instruction to store program tracking information at a location in the instruction bundle that would otherwise be occupied by a no-operation instruction to minimize a performance impact on the program.

18. The system recited in claim 11, wherein the program tracking information is used to determine an execution path leading to a fatal error or crash.

19. The system recited in claim 11, wherein the program is adapted to add the program tracking information after a process of in-lining and prior to a process of if-conversion.

20. A system for providing program tracking information, the system comprising:
means for compiling a program into a plurality of instruction bundles; and
means for placing an instruction to store program tracking information in a local path table or a global path table into at least one of the plurality of instruction bundles.
